(19) United States
(12) Patent Application Publication
(10) Pub. No.: US 2020/0241882 A1
(43) Pub. Date: Jul. 30, 2020

(54) INFORMATION PROCESSING SYSTEM, METHOD OF PROCESSING INFORMATION, AND INFORMATION PROCESSING APPARATUS

(71) Applicants: TAITO SUZUKI, Kanagawa (JP); KAZUYA TANI, Kanagawa (JP)

(72) Inventors: TAITO SUZUKI, Kanagawa (JP); KAZUYA TANI, Kanagawa (JP)

(73) Assignee: Ricoh Company, Ltd., Tokyo (JP)

(21) Appl. No.: 16/741,832

(22) Filed: Jan. 14, 2020

(30) Foreign Application Priority Data
Jan. 24, 2019 (JP) 2019-010626

(51) Int. Cl. G06F 9/38; G06F 11/34

(52) U.S. Cl. CPC G06F 9/3875; G06F 11/3466; G06F 9/383

(57) ABSTRACT

An information processing system includes a first information processing apparatus, an external storage, and a second information processing apparatus. The first information processing apparatus includes first circuitry to execute data transfer from the first information processing apparatus to the external storage, and assign a completion flag to data for which execution of the data transfer has been completed. The second information processing apparatus includes second circuitry to execute data transfer from the external storage to the second information processing apparatus, and assign a completion flag to data for which execution of the data transfer has been completed. The first circuitry is further configured to, after data transfer is interrupted, execute the data transfer of data to which the completion flag is not assigned. The second circuitry is further configured to after the data transfer is interrupted, execute the data transfer of data to which the completion flag is not assigned.

### CROSS-REFERENCE TO RELATED APPLICATION

This patent application is based on and claims priority pursuant to 35 U.S.C. § 119(a) to Japanese Patent Application No. 2019-010626, filed on Jan. 24, 2019, in the Japan Patent Office, the entire disclosure of which is hereby incorporated by reference herein.

### BACKGROUND

### Technical Field

Embodiments of the present disclosure relate to an information processing system, a method of processing information, and an information processing apparatus.

### Description of the Related Art

Data transfer among a plurality of information processing apparatuses (e.g., among image forming apparatuses such as multifunction peripherals) via an external storage is known. Specifically, data stored in a storage device (e.g., a hard disc drive (HDD)) of a given information processing apparatus is transferred to another information processing apparatus via the external storage. Such data transfer is sometimes interrupted due to the occurrence of event of some kind.

To address such interruption of data transfer, a technique is known in which a transfer source apparatus acquires the frame number of a transferred file before the interruption from a transfer destination apparatus, instructs the resume of data transfer with specification of the frame number, and resumes the file transfer based on the specified frame number.

### SUMMARY

According to one or more embodiments, an information processing system includes a first information processing apparatus, an external storage, and a second information processing apparatus. The first information processing apparatus includes first circuitry configured to execute data transfer from the first information processing apparatus to the external storage, and assign a completion flag to data for which execution of the data transfer from the first information processing apparatus to the external storage has been completed. The second information processing apparatus includes second circuitry configured to execute data transfer from the external storage to the second information processing apparatus, and assign a completion flag to data for which execution of the data transfer from the external storage to the second information processing apparatus has been completed. The first circuitry is further configured to, after data transfer is interrupted, execute the data transfer of data to which the completion flag is not assigned from the first information processing apparatus to the external storage. The second circuitry is further configured to after the data transfer is interrupted, execute the data transfer of data to which the completion flag is not assigned from the external storage to the second information processing apparatus.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a block diagram illustrating a configuration of an information processing system, according to an embodiment of the present disclosure;

FIG. 2 is a block diagram illustrating an example of a hardware configuration of an information processing apparatus, according to an embodiment of the present disclosure;

FIG. 3 is a block diagram illustrating an example of a functional configuration of the information processing system, according to an embodiment of the present disclosure;

FIG. 4 is a diagram illustrating an example structure of document data, according to an embodiment of the present disclosure;

FIG. 5 is a flowchart illustrating steps in an export process, according to an embodiment of the present disclosure;

FIG. 6 is a flowchart illustrating steps in an export process, according to an embodiment of the present disclosure;

FIG. 7 is a flowchart illustrating steps in an import process, according to an embodiment of the present disclosure;

FIG. 8 is a flowchart illustrating steps in an import process, according to an embodiment of the present disclosure;

FIG. 9 is a flowchart illustrating steps in an export process, according to an embodiment of the present disclosure; and

FIG. 10 is a flowchart illustrating steps in an import process, according to an embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, a description is given of several embodiments of the present disclosure with reference drawings. In the following description of embodiments and the drawings, the same reference numbers are allocated to elements (members or components) having the same or substantially the same function and redundant descriptions thereof are omitted.

In the present disclosure, the interruption of data transfer is, for example, but not limited to, interruption caused by a user intentionally. The interruption of data transfer further includes, for example, interruption due to disconnection of a communication network such as Wi-Fi, power-off of an information processing apparatus such as an image forming apparatus, or abnormality such as failure in writing data.

System Configuration:

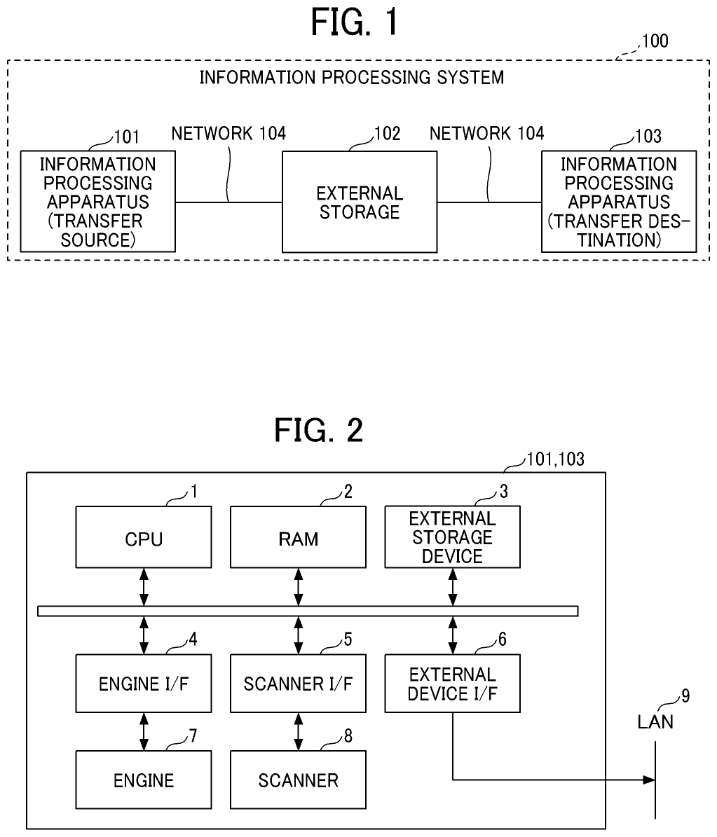

FIG. 1 is a block diagram illustrating a configuration of an information processing system 100, according to an embodiment of the present disclosure. The information processing system 100 includes, for example, an information processing apparatus (transfer source) 101, an external storage 102, and an information processing apparatus (transfer destination) 103. The information processing apparatus (transfer source) 101 and the information processing apparatus (transfer destination) 103 are configured to access the external storage 102 via a network 104 of any type. A description is now given of each of the information processing apparatus (transfer source) 101, the external storage 102 and the information processing apparatus (transfer destination) 103.

The information processing apparatus (transfer source) 101 is an apparatus used as a transfer source, from which data is to be transferred via the external storage 102. Specifically, the information processing apparatus (transfer source) 101 reads out data from a storage device (e.g., a hard disc drive (HDD)) of the information processing apparatus (transfer source) 101 and transfers the read-out data to the external storage 102. Hereinafter, such process may be referred to as “export”.

The information processing apparatus (transfer destination) 103 is an apparatus used as a transfer destination, to which data is to be transferred via the external storage 102. Specifically, the information processing apparatus (transfer destination) 103 acquires data from the external storage 102 and writes the acquired data into a storage device (e.g., an HDD) of the information processing apparatus (transfer destination) 103. Hereinafter, such process may be referred to as “import”.

Each of the information processing apparatus (transfer source) 101 and the information processing apparatus (transfer destination) 103 is, for example, but not limited to, an image forming apparatus. The information processing apparatus (transfer source) 101 and the information processing apparatus (transfer destination) 103 can be any suitable apparatus other than the image forming apparatus, provided that it includes communication capability. Examples of the information processing apparatus (transfer source) 101 and the information processing apparatus (transfer destination) 103 include an output device such as a projector (PJ), an interactive whiteboard (IWB; an electronic whiteboard with mutual communication capability) and a digital signage, a head-up display (HUD), an industrial machine, an imaging device, a sound collecting device, a medical device, a networked home appliance, an automobile (connected car), a laptop computer, a mobile phone, a smartphone, a tablet terminal, a game console, a personal digital assistant (PDA), a digital camera, a wearable personal computer (PC) and a desktop PC.

The external storage 102 is a storage device of any type.

Hardware Configuration:

FIG. 2 is a block diagram illustrating an example of a hardware configuration of the information processing apparatus 101 and the information processing apparatus 103 according to an embodiment of the present disclosure. As illustrated in FIG. 2, the information processing apparatus 101 and the information processing apparatus 103 each include, for example, a central processing unit (CPU) 1, a random access memory (RAM) 2, an external storage device 3, an engine interface (I/F) 4, and a scanner I/F 5, an external device I/F 6, an engine 7, and a scanner 8.

The CPU 1 is a controller that control entire operation of each of the information processing apparatus 101 and the information processing apparatus 103. The RAM 2 is used as a memory that deploys a program and data, or as a drawing memory that stores drawing data for printing. The program stored in the RAM 2 can be stored in any computer-readable storage medium, such as a compact disc-read only memory (CD-ROM), compact disc-recordable (CD-R), or digital versatile disc (DVD), in a file format installable or executable by the computer, for distribution. The external storage device 3 stores various image data, font data for printing, and form data. The engine 7 prints out an image using image data of a document acquired through the engine I/F 4. The scanner 8 reads a document through the scanner I/F 5. The external device I/F 6 is an interface that controls communication of data through a communication network such as a local area network (LAN) 9.

In one embodiment of the present disclosure, the scanner 8 scans a document through the scanner I/F 5, and image data of the scanned document is stored in the RAM 2. Further, additional information of the document is stored in the RAM 2 in association with the image data. When printing is to be performed immediately, the image data of the document and the additional information are sent to the engine I/F 4, and the engine 7 forms an image using the image data of the document. When the scanned document is to be accumulated, the image data of the document and the additional information are accumulated in the external storage device 3.

Functional Configuration:

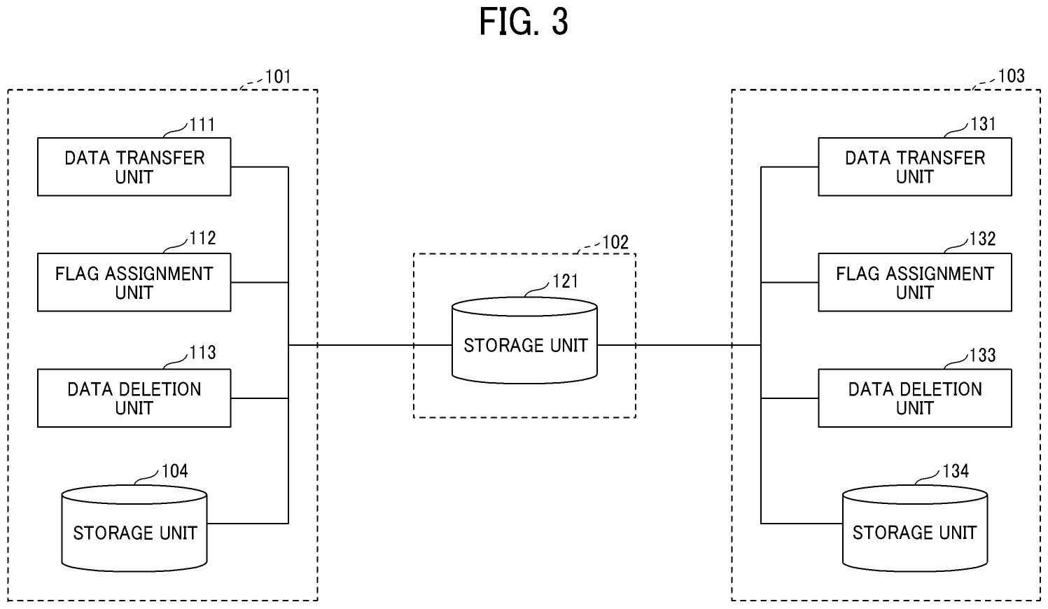

FIG. 3 is a block diagram illustrating an example of a functional configuration of the information processing system 100, according to an embodiment of the present disclosure.

The information processing apparatus (transfer source) 101 includes, for example, a data transfer unit 111, a flag assignment unit 112, a data deletion unit 113, and a storage unit 114. The information processing apparatus (transfer source) 101 executes the program to implement the data transfer unit 111, the flag assignment unit 112, and the data deletion unit 113. A description is given below of each of the data transfer unit 111, the flag assignment unit 112, and the data deletion unit 113.

The external storage 102 includes a storage unit 121. Data in the storage unit 114 of the information processing apparatus (transfer source) 101 is exported to the storage unit 121. Further, the data in the storage unit 121 exported from the information processing apparatus (transfer source) 101 is imported to a storage unit 134 of the information processing apparatus (transfer destination) 103.

The information processing apparatus (transfer destination) 103 includes, for example, a data transfer unit 131, a flag assignment unit 132, a data deletion unit 133, and a storage unit 134. The information processing apparatus (transfer destination) 103 executes a program to implement the data transfer unit 131, the flag assignment unit 132, and the data deletion unit 133. A description is given below of each of the data transfer unit 131, the flag assignment unit 132, and the data deletion unit 133.

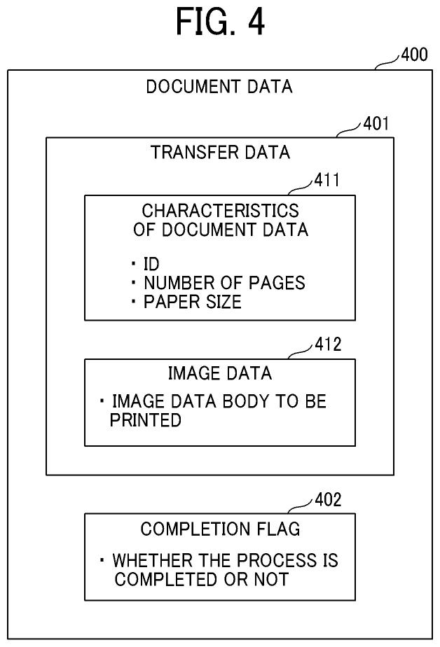

Before describing the information processing apparatus (transfer source) 101 and the information processing apparatus (transfer destination) 103 in detail, a description is now given of data to be transferred, with reference to FIG. 4. In one embodiment of the present disclosure, data of a document scanned by the information processing apparatus (transfer source) 101 is transferred to the information processing apparatus (transfer destination) 103 via the external storage 102.

FIG. 4 is a diagram illustrating an example structure of document data 400, according to an embodiment of the present disclosure. The document data 400 includes, for example, transfer data 401 and a completion flag 402.

The transfer data 401 includes, for example, document data characteristics 411 and image data 412. The transfer data 401 is transferred (i.e., exported) from the storage unit 114 of the information processing apparatus (transfer source) 101 to the storage unit 121 of the external storage 102. Further, the transfer data 401 is transferred (i.e., imported) from the storage unit 121 of the external storage 102 to the storage unit 134 of the information processing apparatus (transfer destination) 103.

The document data characteristics 411 is additional information of the document data 400. For example, the document data characteristics 411 are information on the printing of the document data 400, such as an identifier (ID) identifying the document data 400, the number of pages of the document data 400, and the page size of the document data 400.

The image data 412 is the data body (main data) of the document data 400 (e.g., image data used for printing).

The completion flag 402 is a flag assigned by the flag assigning unit 112 and the flag assignment unit 132. Specifically, the completion flag 402 indicates that a process of transferring (i.e., exporting) the transfer data 401 from the storage unit 114 of the information processing apparatus (transfer source) 101 to the storage unit 121 of the external storage 102 is completed. Further, the completion flag 402 indicates that a process of transferring (i.e., importing) the transfer data 401 from the storage unit 121 of the external storage 102 to the storage unit 134 of the information processing apparatus (transfer destination) 103 is completed.

Export Process:

A detailed description is now given of the information processing apparatus (transfer source) 101.

The data transfer unit 111 performs data transfer in transferring data between information processing apparatuses. The data transfer unit 111 reads out data from the storage unit 114 and transfers (i.e., exports) the read-out data to the storage unit 121 of the external storage 102.

Specifically, the data transfer unit 111 acquires a list indicating all pieces of the document data 400 stored in the storage unit 114. Further, the data transfer unit 111 determines whether the completion flag 402 has been checked for up to document data 400 that is to be transferred last based on the list indicating all pieces of the document data 400 stored in the storage unit 114. Further, the data transfer unit 111 reads out the document data 400 stored in the storage unit 114 and refers to the completion flag 402 of the read-out document data 400. In a case where the completion flag 402 is assigned to the document data 400, the data transfer unit 111 does not transfer the transfer data 401 to the storage unit 121 of the external storage 102. In a case where the completion flag 402 is not assigned to the document data 400, the data transfer unit 111 transfers the transfer data 401 to the storage unit 121 of the external storage 102. In other words, when the completion flag 402 is assigned to the document data 400, the data transfer unit 111 determines that the transfer data 401 is data that has been already transferred. In contrast, the data transfer unit 111 determines that the transfer data 401 is data that has not been transferred yet, when the completion flag 402 is not assigned to the document data 400.

The flag assignment unit 112 assigns the completion flag 402 to the document data 400 in the storage unit 114 of the information processing apparatus (transfer source) 101 after the data transfer unit 111 completes a data transfer process of the transfer data 401. Further, the flag assignment unit 112 assigns the completion flag 402 to the document data 400 in the storage unit 121 of the external storage 102 after the data transfer unit 111 completes a data transfer process of the transfer data 401.

After the data transfer unit 111 completes a data transfer process of the transfer data 401, the data deletion unit 113 deletes the document data 400 for which the data transfer process has been competed from among the document data 400 stored in the storage unit 114 of the information processing apparatus (transfer source) 101.

The storage unit 114 stores the document data 400 that is to be exported to the storage unit 121 of the external storage 102.

Organization of Data in External Storage:

The data transfer unit 111 is further configured to organize the document data 400 in the storage unit 121 of the external storage 102. Specifically, the data transfer unit 111 acquires a list indicating all pieces of the document data 400 stored in the storage unit 121 of the external storage 102. Further, the data transfer unit 111 determines whether the completion flag 402 has been checked for up to document data 400 that is to be transferred last based on the list indicating all pieces of the document data 400 stored in the storage unit 121 of the external storage 102. Further, the data transfer unit 111 refers to the completion flag 402 of document data 400 stored in the storage unit 121 of the external storage 102. In a case where the completion flag 402 is not assigned to the document data 400, the data transfer unit 111 deletes such document data 400. Thus, the data transfer unit 111 can find out document data 400 that is incomplete data because the data transfer is interrupted due to occurrence of an abnormality or the like.

Import:

A detailed description is now given of the information processing apparatus (transfer destination) 103.

The data transfer unit 131 performs data transfer in transferring data between information processing apparatuses. The data transfer unit 131 acquires data from the external storage 102 and writes (i.e., imports) the acquired data into the storage unit 134.

Specifically, the data transfer unit 131 acquires a list indicating all pieces of the document data 400 stored in the storage unit 121 of the external storage 102. Further, the data transfer unit 131 determines whether the completion flag 402 has been checked for up to document data 400 that is to be transferred last based on the list indicating all pieces of the document data 400 stored in the storage unit 121 of the external storage 102. Further, the data transfer unit 131 refers to the completion flag 402 of document data 400 in the external storage 102. In a case where the completion flag 402 is assigned to the document data 400, the data transfer unit 131 does not transfer the transfer data 401 to the storage unit 134. In a case where the completion flag 402 is not assigned to the document data 400, the data transfer unit 131 transfer the transfer data 401 to the storage unit 134. In other words, when the completion flag 402 is assigned to the document data 400, the data transfer unit 131 determines that the transfer data 401 is data that has been already transferred. In contrast, the data transfer unit 131 determines that the transfer data 401 is data that has not been transferred yet, when the completion flag 402 is not assigned to the document data 400.

After the data transfer unit 131 completes a data transfer process of the transfer data 401, the flag assignment unit 132 assigns the completion flag 402 to the document data 400 stored in the storage unit 121 of the external storage 102. Further, the flag assignment unit 132 assigns the completion flag 402 to the document data 400 stored in the storage unit 134 of the information processing apparatus (transfer destination) 103 after the data transfer unit 131 completes a data transfer process of the transfer data 401.

After the data transfer unit 131 completes a data transfer process of the transfer data 401, the data deletion unit 133 deletes the document data 400 for which the data transfer process has been competed from among the document data 400 stored in the storage unit 121 of the external storage 102.

The storage unit 134 stores the document data 400 imported from the storage unit 121 of the external storage 102.

Organization of Data in Information Processing Apparatus (Transfer Destination):

The data transfer unit 131 is further configured to organize document data 400 in the storage unit 134. Specifically, the data transfer unit 131 acquires a list indicating all pieces of the document data 400 stored in the storage unit 134. Further, the data transfer unit 131 determines whether the completion flag 402 has been checked for up to document data 400 that is to be transferred last based on the list indicating all pieces of document data 400 stored in the storage unit 134. Further, the data transfer unit 131 refers to the completion flag 402 of document data 400 stored in the storage unit 134. In a case where the completion flag 402 is not assigned to the document data 400, the data transfer unit 131 deletes such document data 400. Thus, the data transfer unit 131 finds out document data 400 that is incomplete data because the data transfer is interrupted due to occurrence of an abnormality or the like.

Export Process According to First Embodiment:

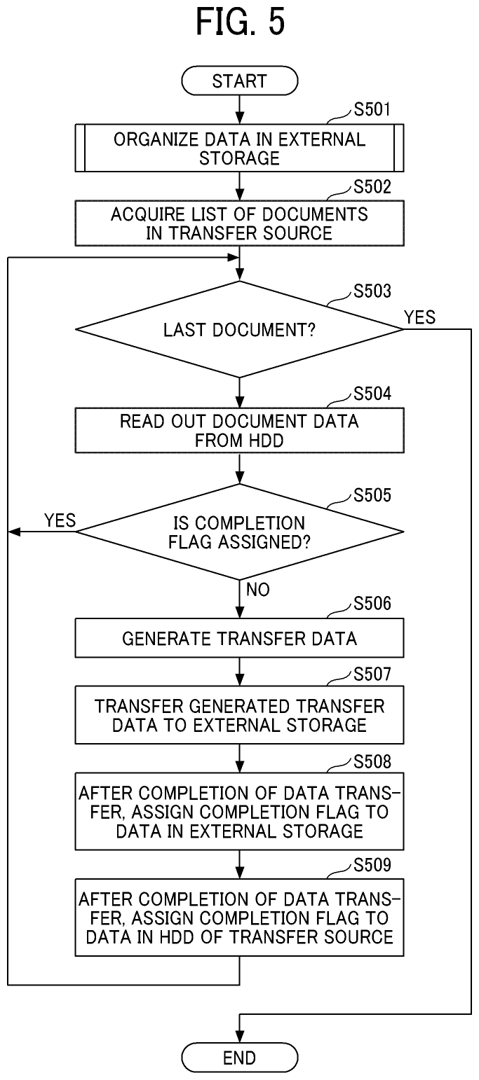

FIG. 5 is a flowchart illustrating steps in an export process, according to an embodiment of the present disclosure. Hereinafter, a description is given on the assumption that data transfer is interrupted before performing the process illustrated in FIG. 5.

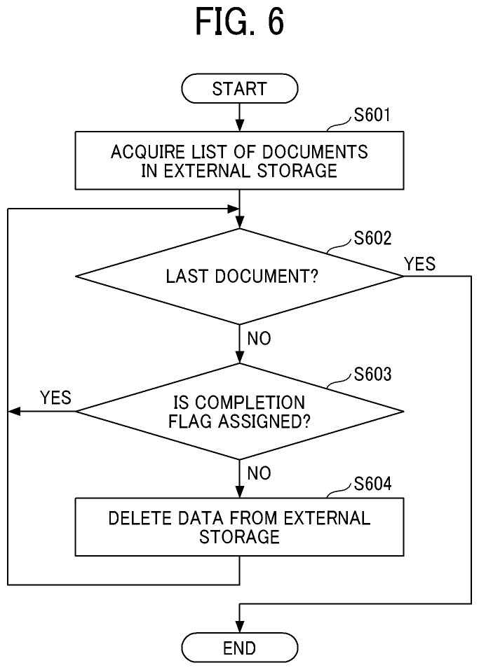

In step 501 (S501), the data transfer unit 111 organizes the document data 400 in the storage unit 121 of the external storage 102. A detailed description is given later of S501 with reference to FIG. 6.

In step 502 (S502), the data transfer unit 111 acquires a list indicating all pieces of the document data 400 stored in the storage unit 114.

In step 503 (S503), the data transfer unit 111 determines whether the completion flag 402 has been checked for up to document data 400 that is to be transferred last, based on the list acquired in S502. When the check of the completion flag 402 is completed for up to the document data 400 that is to be transferred last, the process ends. By contrast, when the check of the completion flag 402 is not completed for up to the document data 400 that is to be transferred last, the process proceeds to step 504.

In step 504 (S504), the data transfer unit 111 reads out the document data 400 stored in the storage unit 114.

In step 505 (S505), the data transfer unit 111 refers to the completion flag 402 of the document data 400 that is read out in S504. When the completion flag 402 is assigned to the document data 400, the process proceeds to step 503. When the completion flag 402 is not assigned to the document data 400, the process proceeds to step 506.

In S506 (S506), the data transfer unit 111 generates transfer data 401 of the document data 400 that is read out in S504. For example, the data transfer unit 111 acquires the transfer data 401 from the storage unit 114. Note that the data transfer unit 111 generates the transfer data 401 so that the transfer data 401 can be transferred in a transfer format that matches the destination to which the transfer data 401 is to be transferred (e.g., the information processing apparatus (transfer destination) 103) as needed.

In step 507 (S507), the data transfer unit 111 transfers the transfer data 401 that is generated in S506 to the storage unit 121 of the external storage 102.

In step 508 (S508), the flag assignment unit 112 assigns a completion flag 402 to the document data 400 that is transferred in S507 and stored in the storage unit 121 of the external storage 102.

In step 509 (S509), the flag assignment unit 112 assigns a completion flag 402 to the document data 400 for which the transfer in S507 has been performed in the storage unit 114 of the information processing apparatus (transfer source) 101. Then, the process returns to S503. Note that the order of steps S508 and S509 may be reversed.

FIG. 6 is a flowchart illustrating steps in an export process, according to an embodiment of the present disclosure. Specifically, FIG. 6 is a flowchart illustrating detailed steps performed in step S501 of FIG. 5, i.e., a process of organizing data in the external storage 102.

In step 601 (S601), the data transfer unit 111 acquires a list indicating all pieces of the document data 400 stored in the storage unit 121 of the external storage 102.

In step 602 (S602), the data transfer unit 111 determines whether the completion flag 402 has been checked for up to document data 400 that is to be transferred last, based on the list acquired in S601. When the check of the completion flag 402 is completed for up to the document data 400 that is to be transferred last, the process of FIG. 6 ends. By contrast, when the check of the completion flag 402 is not completed for up to the document data 400 that is to be transferred last, the process proceeds to step 603.

In step 603 (S603), the data transfer unit 111 refers to the completion flag 402 of the document data 400 stored in the storage unit 121 of the external storage 102. When the completion flag 402 is assigned to the document data 400, the process proceeds to step 602. When the completion flag 402 is not assigned to the document data 400, the process proceeds to step 604.

In step 604 (S604), the data transfer unit 111 deletes the document data 400 for which the data transfer unit 111 determines in S603 that a completion flag is not assigned to the document data 400. Then, the process returns to S602.

Import Process According to First Embodiment:

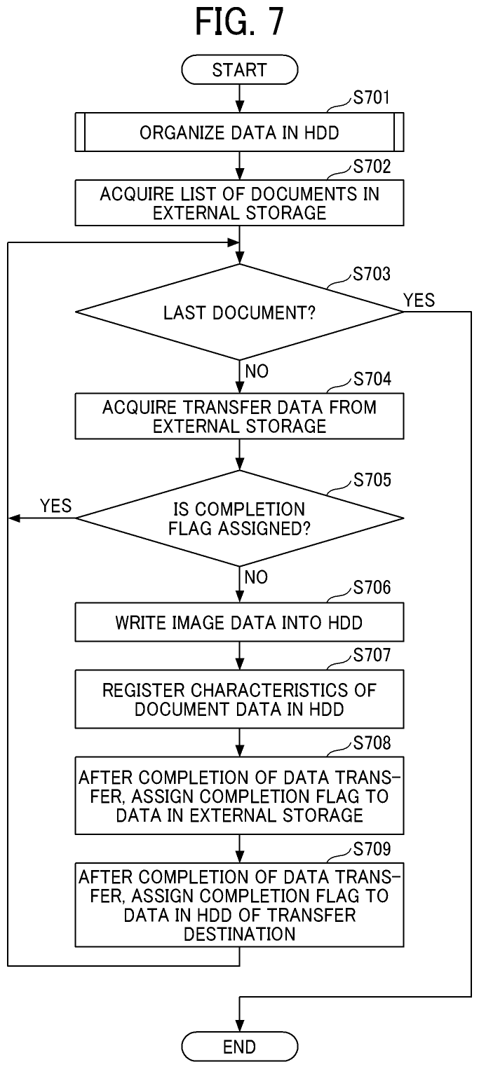

FIG. 7 is a flowchart illustrating steps in an import process, according to an embodiment of the present disclosure. Hereinafter, a description is given on the assumption that data transfer is interrupted before performing the process illustrated in FIG. 7.

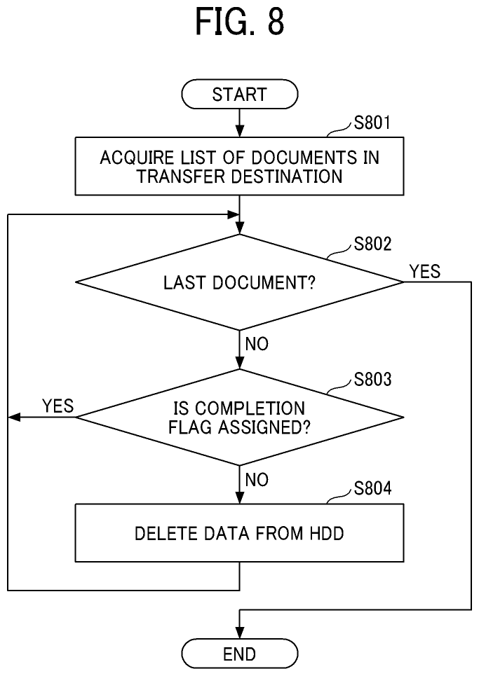

In step 701 (S701), the data transfer unit 131 organizes the document data 400 in the storage unit 134. A detailed description of S701 is given later with reference to FIG. 8.

In step 702 (S702), the data transfer unit 131 acquires a list indicating all pieces of the document data 400 stored in the storage unit 121 of the external storage 102.

In step 703 (S703), the data transfer unit 131 determines whether the completion flag 402 has been checked for up to document data 400 that is to be transferred last, based on the list acquired in S702. When the check of the completion flag 402 is completed for up to the document data 400 that is to be transferred last, the process ends. By contrast, when the check of the completion flag 402 is not completed for up to the document data 400 that is to be transferred last, the process proceeds to step 704.

In step 704 (S704), the data transfer unit 131 acquires transfer data 401 from the storage unit 121 of the external storage 102.

In step 705 (S705), the data transfer unit 131 refers to the completion flag 402 of the transfer data 401 that is acquired in step S704. When the completion flag 402 is assigned to the transfer data 401, the process proceeds to step 703. When the completion flag 402 is not assigned to the transfer data 401, the process proceeds to step 706.

In step 706 (S706), the data transfer unit 131 writes the image data 412 of the transfer data 401 that is acquired in S704 into the storage unit 134.

In step 707 (S707), the data transfer unit 131 registers the document data characteristics 411 of the transfer data 401 that is acquired in step S704 in the storage unit 134.

In step 708 (S708), the flag assignment unit 132 assigns a completion flag 402 to the document data 400 for which the writing in S706 and the registration in S707 have been performed in the storage unit 121 of the external storage 102.

In step 709 (S709), the flag assignment unit 132 assigns a completion flag 402 to the document data 400 for which the writing in S706 and the registration in S707 have been performed in the storage unit 134 of the information processing apparatus (transfer destination) 103. Then, the process returns to S703. Note that the order of steps S708 and S709 may be reversed.

FIG. 8 is a flowchart illustrating steps in an import process, according to an embodiment of the present disclosure. Specifically, FIG. 8 is a flowchart illustrating detailed steps performed in step S701 of FIG. 7, i.e., a process of organizing data in the information processing apparatus (transfer destination) 103.

In step 801 (S801), the data transfer unit 131 acquires a list indicating all pieces of document data 400 stored in the storage unit 134.

In step 802 (S802), the data transfer unit 131 determines whether the completion flag 402 has been checked for up to document data 400 that is to be transferred last, based on the list acquired in S801. When the check of the completion flag 402 is completed for up to the document data 400 that is to be transferred last, the process ends. By contrast, when the check of the completion flag 402 is not completed for up to the document data 400 that is to be transferred last, the process proceeds to step 803.

In step 803 (S803), the data transfer unit 131 refers to the completion flag 402 of the document data 400 stored in the storage unit 134. When the completion flag 402 is assigned to the document data 400, the process proceeds to step 802. When the completion flag 402 is not assigned to the document data 400, the process proceeds to step 804.

In step 804 (S804), the data transfer unit 131 deletes the document data 400 for which the data transfer unit 111 determines in S803 that a completion flag is not assigned.

Then, the process returns to S802.

Export Process According to Second Embodiment:

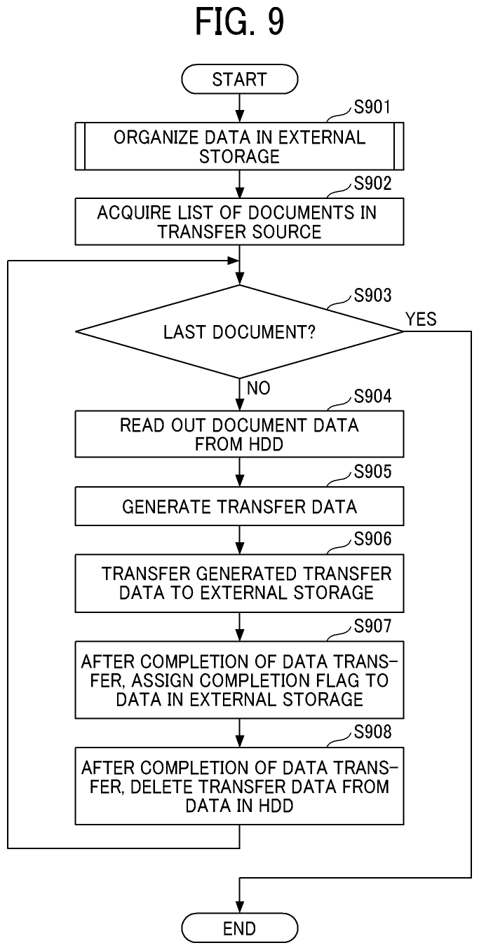

FIG. 9 is a flowchart illustrating steps in an export process, according to an embodiment of the present disclosure. Hereinafter, a description is given on the assumption that data transfer is interrupted before performing the process illustrated in FIG. 9.

In step 901 (S901), the data transfer unit 111 organizes document data 400 in the storage unit 121 of the external storage 102. The process of S901 is performed in the same or substantially the same manner as described above with reference to FIG. 6.

In step 902 (S902), the data transfer unit 111 acquires a list indicating all pieces of the document data 400 stored in the storage unit 114.

In step 903 (S903), the data transfer unit 111 determines whether the completion flag 402 has been checked for up to document data 400 that is to be transferred last, based on the list acquired in S902. When the check of the completion flag 402 is completed for up to the document data 400 that is to be transferred last, the process ends. By contrast, when the check of the completion flag 402 is not completed for up to the document data 400 that is to be transferred last, the process proceeds to step 904.

In step 904 (S904), the data transfer unit 111 reads out the document data 400 stored in the storage unit 114.

In S905 (S905), the data transfer unit 111 generates transfer data 401 of the document data 400 that is read out in S904. For example, the data transfer unit 111 acquires transfer data 401 from the storage unit 114.

In step 906 (S906), the data transfer unit 111 transfers the transfer data 401 that is generated in S905 to the storage unit 121 of the external storage 102.

In step 907 (S907), the flag assignment unit 112 assigns a completion flag 402 to the document data 400 that is transferred in S906 in the storage unit 121 of the external storage 102.

In step 908 (S908), the data deletion unit 113 deletes the document data 400 for which the transfer in S906 has been performed in the storage unit 114 of the information processing apparatus (transfer source) 101. Then, the process returns to S903. Note that the order of steps S907 and S908 may be reversed.

Import Process According to Second Embodiment:

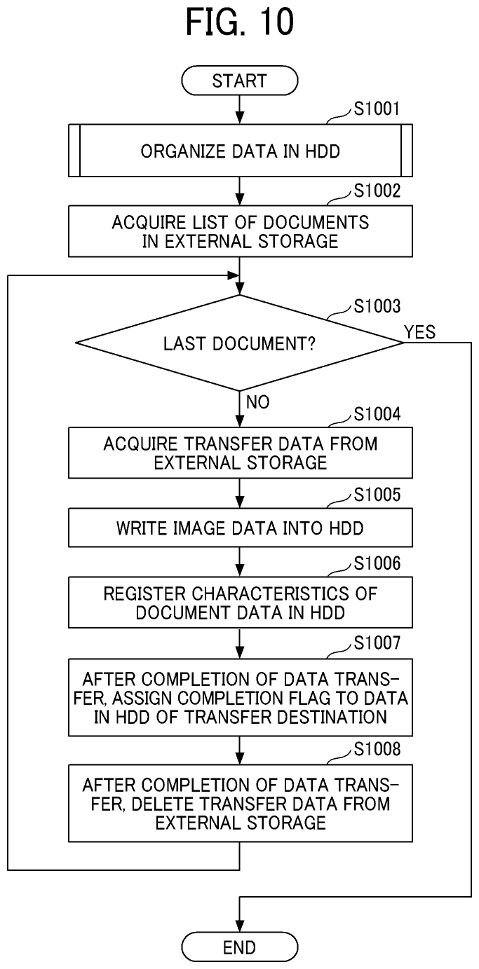

FIG. 10 is a flowchart illustrating steps in an import process, according to an embodiment of the present disclosure. Hereinafter, a description is given on the assumption that data transfer is interrupted before performing the process illustrated in FIG. 10.

In step 1001 (S1001), the data transfer unit 131 organizes the document data 400 in the storage unit 134. The process of S1001 is performed in the same or substantially the same manner as described above with reference to FIG. 8.

In step 1002 (S1002), the data transfer unit 131 acquires a list indicating all pieces of the document data 400 stored in the storage unit 121 of the external storage 102.

In step 1003 (S1003), the data transfer unit 131 determines whether the completion flag 402 has been checked for up to document data 400 that is to be transferred last, based on the list acquired in S1002. When the check of the completion flag 402 is completed for up to the document data 400 that is to be transferred last, the process ends. By contrast, when the check of the completion flag 402 is not completed for up to the document data 400 that is to be transferred last, the process proceeds to step 1004.

In step 1004 (S1004), the data transfer unit 131 acquires transfer data 401 from the storage unit 121 of the external storage 102.

In step 1005 (S1005), the data transfer unit 131 writes the image data 412 of the transfer data 401 that is acquired in S1004 into the storage unit 134.

In step 1006 (S1006), the data transfer unit 131 registers the document data characteristics 411 of the transfer data 401 that is acquired in step S1004 in the storage unit 134.

In step 1007 (S1007), the flag assignment unit 132 assigns a completion flag 402 to the document data 400 for which the writing in S1005 and the registration in S1006 have been performed in the storage unit 134 of the information processing apparatus (transfer destination) 103.

In step 1008 (S1008), the data deletion unit 133 deletes the document data 400 for which the writing in S1005 and the registration in S1006 have been performed in the storage unit 121 of the external storage 102. Then, the process returns to S1003. Note that the order of steps S1007 and S1008 may be reversed.

Thus, interrupted data transfer is resumed in an efficient manner. In the export process and import process according to the first embodiment, the completion flag of data stored in the transfer source of data transfer is checked so that data that has not been transferred yet (i.e., data to which the completion flag is not as assigned) is transferred. In the export process and import process according to the second embodiment, a check process of the completion flag of data stored in the transfer source to determine whether data has been already transferred can be omitted. In the export process and import process according to the first and second embodiments, incomplete data (i.e., data for which data transfer has been interrupted) in the transfer destination is found.

According to the related art, the transfer source apparatus needs to acquire from the transfer destination apparatus the frame number of a file transferred before the interruption of data transfer.

According to one or more embodiments of the present disclosure, interrupted data transfer can be resumed in an efficient manner.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

What is claimed is:

1. An information processing system comprising:
a first information processing apparatus;
an external storage; and
a second information processing apparatus,
the first information processing apparatus including first circuitry configured to:
execute data transfer from the first information processing apparatus to the external storage; and
assign a completion flag to data for which execution of the data transfer from the first information processing apparatus to the external storage has been completed,
the second information processing apparatus including second circuitry configured to:
execute data transfer from the external storage to the second information processing apparatus; and
assign a completion flag to data for which execution of the data transfer from the external storage to the second information processing apparatus has been completed, wherein
the first circuitry is further configured to, after data transfer is interrupted, execute the data transfer of data to which the completion flag is not assigned from the first information processing apparatus to the external storage, and
the second circuitry is further configured to after the data transfer is interrupted, execute the data transfer of data to which the completion flag is not assigned from the external storage to the second information processing apparatus.

2. The information processing system of claim 1, wherein
the first circuitry is further configured to assign the completion flag to data that is stored in the first information processing apparatus and for which the execution of the data transfer from the first information processing apparatus to the external storage has been completed and data that is stored in the external storage and for which the execution of the data transfer from the first information processing apparatus to the external storage has been completed, and
the second circuitry is further configured to assign the completion flag to data that is stored in the external storage and for which the execution of the data transfer from the external storage to the second information processing apparatus has been completed and data that is stored in the second information processing apparatus and for which the execution of the data transfer from the external storage to the second information processing apparatus has been completed.

3. The information processing system of claim 1, wherein
the first circuitry is further configured to assign the completion flag to data that is stored in the external storage and for which execution of the data transfer from the first information processing apparatus to the external storage has been completed,
the second circuitry is further configured to assign the completion flag to data that is stored in the second information processing apparatus and for which execution of the data transfer from the external storage to the second information processing apparatus has been completed,
the first circuitry is further configured to delete data that is stored in the first information processing apparatus and for which the execution of the data transfer from the first information processing apparatus to the external storage has been completed, and
the second circuitry is further configured to delete data that is stored in the external storage and for which the execution of the data transfer from the external storage to the second information processing apparatus has been completed.

4. The information processing system of claim 1, wherein
the first circuitry is further configured to delete data that is stored in the external storage and for which the execution of the data transfer from the first information processing apparatus to the external storage has not been completed, and
the second circuitry is further configured to delete data that stored is in the second information processing apparatus and for which the execution of the data transfer from the external storage to the second information processing apparatus has not been completed.

5. A method performable by an information processing system including a first information processing apparatus, an external storage, and a second information processing apparatus, the method comprising:
executing data transfer from the first information processing apparatus to the external storage;
assigning a completion flag to data for which execution of the data transfer from the first information processing apparatus to the external storage has been completed;
after data transfer is interrupted, executing the data transfer of data to which the completion flag is not assigned from the first information processing apparatus to the external storage;
executing data transfer from the external storage to the second information processing apparatus;
assigning a completion flag to data for which execution of the data transfer from the external storage to the second information processing apparatus has been completed; and
after data transfer is interrupted, executing the data transfer of data to which the completion flag is not assigned from the external storage to the second information processing apparatus.

6. The method of claim 5, wherein
the completion flag is assigned to data that is in the first information processing apparatus and for which execution of the data transfer from the first information processing apparatus to the external storage has been completed and data that is stored in the external storage and for which the execution of the data transfer from the first information processing apparatus to the external storage has been completed, and
the completion flag is assigned to data that is stored in the external storage and for which the execution of the data transfer from the external storage to the second information processing apparatus has been completed and data that is stored in the second information processing apparatus and for which the execution of the data transfer from the external storage to the second information processing apparatus has been completed.

7. The method of claim 5, wherein
the completion flag is assigned to data stored in the external storage for which execution of the data transfer from the first information processing apparatus to the external storage has been completed,
the completion flag is assigned to data stored in the second information processing apparatus for which the execution of the data transfer from the external storage to the second information processing apparatus has been completed, and
the method further comprising:
deleting the data that is stored in the first information processing apparatus and for which the execution of the data transfer from the first information processing apparatus to the external storage has been completed; and
deleting the data that is stored in the external storage and for which the execution of the data transfer from the external storage to the second information processing apparatus has been completed.

8. The method of claim 5, further comprising:
deleting data that is in the external storage and for which the execution of the data transfer from the first information processing apparatus to the external storage has not been completed; and
deleting data that is in the second information processing apparatus and for which the execution of the data transfer from the external storage to the second information processing apparatus has not been completed.

9. An information processing apparatus comprising: circuitry configured to
execute data transfer from the information processing apparatus to an external storage; and
assign a completion flag to data for which execution of the data transfer has been completed, wherein
the circuitry is further configured to, after data transfer is interrupted, execute the data transfer of data to which the completion flag is not assigned.
